(19) United States
(12) Patent Application Publication
(10) Pub. No.: US 2009/0086468 A1
(43) Pub. Date: Apr. 2, 2009

(54) BICYCLE HELMET MOUNTED SAFETY LIGHT

(76) Inventor: James Carillo, Long Beach, CA (US)

Correspondence Address: AVERILL & VARN, 8244 PAINTER AVE., WHITTIER, CA, 90602, US

(21) Appl. No.: 12/240,667

(22) Filed: Sep. 29, 2008

Related U.S. Application Data
(60) Provisional application No. 60/997,109, filed on Sep. 29, 2007.

(51) Int. Cl. F21V 21/084

(52) U.S. Cl. 362/106

(57) ABSTRACT

A bicycle helmet includes lights providing illuminating beams toward a rider's upper torso. The lights reside on a downward and rearward facing surface of an elongated rear portion of the bicycle helmet. A light assembly unit is mounted to the elongated rear portion of the bicycle helmet. The light assembly unit includes one or more light elements, a power source, and a switch. The light elements are preferably Light Emitting Diodes (LEDs) providing long battery life.

The present application claims the priority of U.S. Provisional Patent Application Ser. No. 60/997,109 filed Sep. 29, 2007 which application is incorporated in its entirety herein by reference.

### BACKGROUND OF THE INVENTION

The present invention relates to bicycle safety lighting and in particular to lighting mounted to a bicycle helmet and directed to illuminate a rider's upper torso.

Bicycle riding has been both a form of transportation and recreation for many years and in many parts of the world. When such riding occurs in low light and/or dark conditions, the safety of the rider depends upon the rider's ability to see the road surface ahead and more importantly being able to be seen by motor vehicle operators using the road.

Various safety devices, generally comprising reflectors and/or lights, are known and used by bicycle riders. Most bicycles are sold with reflectors, however such reflectors are small and depend on light being directed towards them. Both forward facing and rearward facing lights are also common, and are generally mounted on or near handle bars, or under the bicycle seat. While such lights provide some added visibility to the rider, they are often not sufficiently conspicuous to motor vehicle operators.

Several attempts have been made to provide an elevated lighting for bicycles based on the belief that a higher light is more visible. Such elevated devices are described in U.S. Pat. Nos. 4,049,959, and 4,309,741. Unfortunately, while these are intuitively attractive, in practice they have failed to gain acceptance, possibly because of the ungainly appearance, and because they do not provide a significant improvement in visibility compared to existing lights.

Other attempts have been made to provide safety lighting to improve the visibility of motorcycle riders. U.S. Pat. No. 5,072,339 discloses a light residing towards the rear of motorcycle seating, which light illuminates a rider's back to improve visibility. Unfortunately, such lighting fails to illuminate an easily identifiable portion of the rider, especially when the rider is leaning forward on the handle bars, and is not likely to cause a motor vehicle operator to immediately identify the rider and provide increased safety.

U.S. patent application Ser. No. 11/810,604 filed Jun. 6, 2007 by the present applicant addresses many of the needs identified above by providing lights mountable to the bicycle frame behind the rider's legs to direct light beams onto the rider's moving legs. The illumination of the rider's moving legs attracts the attention of motor vehicle operators and thereby significantly improves rider safety. While the '604 application provides a good solution to rider safety, some riders may prefer a simple single device over the two lights disclosed in the '604 application.

While the lights disclosed in the '604 application provide a significant improvement over known lights, some riders prefer a single device over a combination of two cooperating devices. U.S. patent application Ser. No. 12/210,963 filed Sep. 15, 2008 by the present applicant discloses a simple single device providing the illumination of the '604 application. The '604 and 963 applications are herein incorporated by reference in their entirety. While the safety lights described in the '604 and 963 applications provide an excellent solution in the form of bicycle mounted lighting, some riders may prefer lighting which is not mounted to the bicycle.

Known helmets, for example as disclosed in U.S. Pat. No. 6,464,369 for “Helmet With Safety Light”, and U.S. Pat. No. 5,327,588 for “Safety Helmet for Cyclists”, include lights. However, the lights of the '369 and '588 patents simply provide an illuminated design or shape on a helmet. Such designs are shapes are not uniquely associated with cyclists, and often to not alert a motor vehicle operator to the presence of a cyclist.

### BRIEF SUMMARY OF THE INVENTION

The present invention addresses the above and other needs by providing a bicycle helmet which includes lights providing illuminating beams toward a rider's upper torso. The lights reside on a downward and rearward facing surface of an elongated rear portion of the bicycle helmet. A light assembly unit is mounted to the elongated rear portion of the bicycle helmet. The light assembly unit includes one or more light elements, a power source, and a switch. The light elements are preferably Light Emitting Diodes (LEDs) providing long battery life.

In accordance with one aspect of the invention, there is provided a rider illuminating bicycle helmet. The helmet includes an elongated rear portion having a rearward and downward facing face on the elongated rear portion. A light assembly unit is mounted to the rearward and downward facing face. The light assembly unit includes at least one light element and a power source for the at least one light element.

In accordance with another aspect of the invention, there is provided a rider illuminating bicycle helmet providing increased bicycle rider visibility during low light/dark conditions thereby improving safety for the rider by directly illuminating the rear surface of the upper torso of the rider. As a result: the rider will be more visible as a bicycle and rider to a vehicle approaching the bicycle from the rear. The rider illuminating bicycle helmet includes a safety bicycle helmet, meeting current CPSC standards for bicycle helmets, a light assembly unit mounted on the rear of the helmet, and provides a light beam inclined down at a 45-75 degree angle below the horizontal plane. The light beam projecting from the rear of the helmet to directly illuminate the rear surface of the upper torso of the rider, the light assembly unit extending outside the smooth shape of the bicycle helmet.

In accordance with yet another aspect of the invention, there is provided a rider illuminating bicycle helmet providing advantages including:

Illuminates the rear surface of the upper torso of the bicyclist ahead, to a allow a vehicle operator approaching from the rear, to more easily identify the bicycle and rider than known lights, improving bicyclist safety;

The mounted light unit will be directed rearward at a 45-75 degree angle below the horizontal plane to maximize direct illumination of the rear surface of the upper torso of the bicyclist to increase rider visibility not presently offered by existing lights;

The rear surface of the upper torso of the bicycle rider is illuminated directly by the light mounted on the rear of the bicycle safety helmet as opposed to existing helmet lights that are meant to be lights directed toward the approaching vehicle as point sources of light;

The light sources do not compromise the structural integrity or aerodynamic properties of the helmet and will be light weight;

Does not depend upon reflected light originating from the approaching vehicle and the angle of the light source to the reflector;

May have a remote battery source positioned in the helmet to counterbalance the weight of the light at the rear of the helmet improving the overall balance of the helmet;

Helmet will maximize ventilation through vents for cooling;

Circuitry maximized for long battery life;

Helmet will satisfy CPSC standards for bicycle helmets and thereby provide protection to the head by absorbing the energy of impact to the head;

The light assembly unit will prevent neck injury in the event of impact upon the light assembly unit because it does not extend outside the smooth shape of the bicycle helmet and thus prevent abrupt unpredictable movement of the head; and

Protective padding will be applied to inside surface of light assembly unit to protect the occipital area of the bicycle rider in the event of direct impact to the fixture.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 shows a bicycle helmet with a safety light according to the present invention carried on a rider's head.

FIG. 2 is a rear view of the bicycle helmet with a safety light according to the present invention.

FIG. 3 shows the rider riding a bicycle and wearing the bicycle helmet with a safety light according to the present invention.

FIG. 4A is a perspective view of a light assembly unit according to the present invention of the bicycle helmet with a safety light.

FIG. 4B is a rear view of the light assembly unit according to the present invention of the bicycle helmet with a safety light.

FIG. 4C is a side view of the light assembly unit according to the present invention of the bicycle helmet with a safety light.

FIG. 5 is a cross-sectional view of the light assembly unit taken along line 5-5 of FIG. 4B.

FIG. 6 is a second bicycle helmet 34a molded to accept a second light assembly unit according to the present invention.

FIG. 7 is a bottom view of the second light assembly unit.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

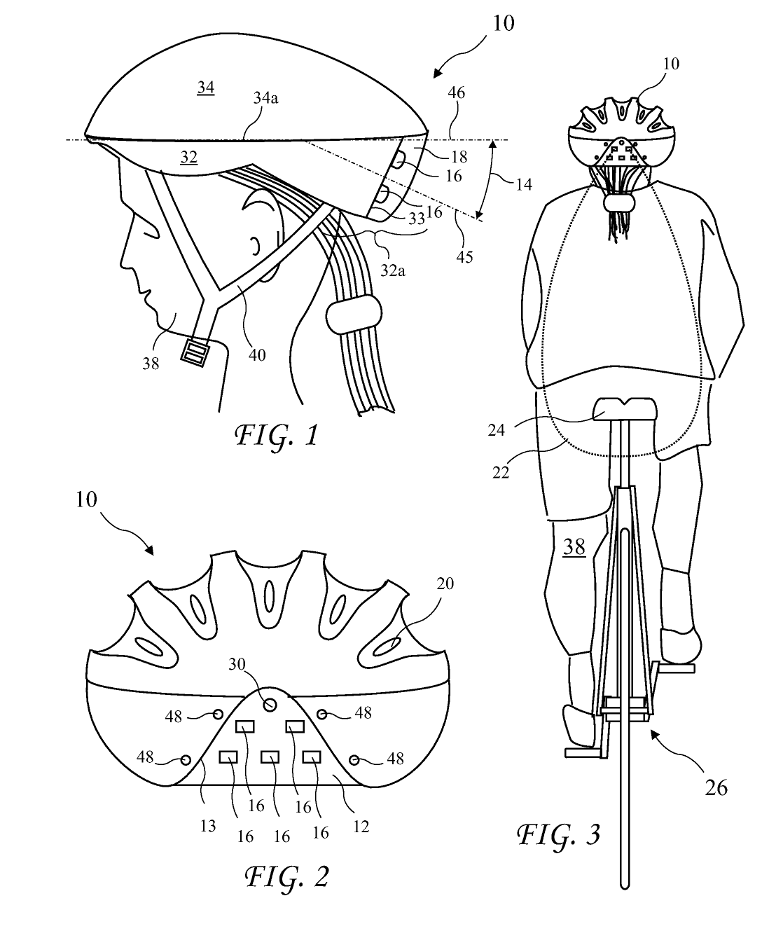

A bicycle helmet 10 with a safety light according to the present invention carried on a rider's head 38 is shown in FIG. 1, a rear view of the bicycle helmet with a safety light 10 is shown in FIG. 2, and the rider 38 riding a bicycle and wearing the bicycle helmet with a safety light 10 is shown in FIG. 3. The helmet includes an outer plastic shell 34 having cooling vents 20 on an upper portion and an exposed lower rim 32. Such outer plastic shell 34 and exposed lower rim 32 are common on known bicycle helmets, for example an Airblaster RL helmet made by Giro. Many such helmets include an elongated rear portion 32a. The elongated rear portion 32a includes a rearward and downward facing face 33. Such helmets are generally held on the rider's head by a retention strap 40.

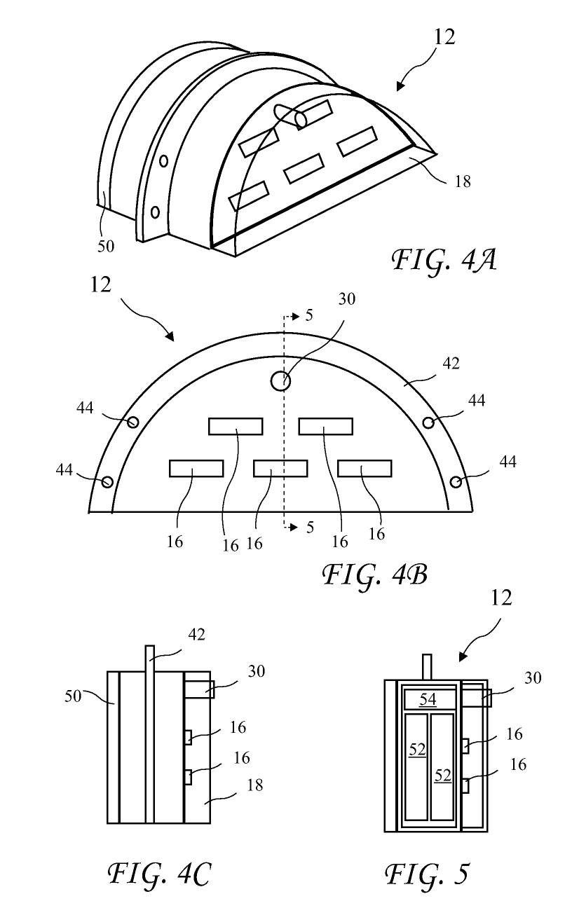

A downward opening cutout 13 in the face 33 is provided for a light assembly unit 12 (see FIGS. 4A-4C for details of the light assembly unit 12). The light assembly unit 12 includes at least one light element 16 to provide a light beam 22. In a typical riding position with the rider 38 sitting on the bicycle 26 seat 24 bent forward and with the head raised, the light beam 22 tangentially grazes that rider's back to clearly illuminate the rider to motor vehicle operators closing from behind the rider 38.

A lower edge 34a of the outer plastic shell 34 generally defines a horizontal axis 46 of the helmet. The actual orientation of the lower edge 34a will vary depending on how the rider 38 wears the helmet 10 and how the rider holds their head. However, the lower edge 34a will generally be nearly horizontal, or at least close enough to horizontal to provide the desired result of illuminating the rider's back. A line 45 perpendicular to the rearward and downward facing face 33 is preferably between 45 and 75 degrees below the horizontal axis 46. The light beam 22 emitted from the light assembly unit 12 is approximately centered on the line 45.

The light assembly unit 12 may be mounted to the helmet using any appropriate means. In one embodiment, the light assembly unit 12 cooperates with four holes 48 molded into the exposed lower rim 32 of the helmet. The light assembly unit 12 may further be mounted from the inside or to the outside of the rearward and downward facing face 33.

A perspective view of the light assembly unit 12 according to the present invention is shown in FIG. 4A, a rear view of the light assembly unit 12 is shown in FIG. 4B, and a side view of the light assembly unit 12 is shown in FIG. 4C. The light assembly unit 12 is shown with an approximately semicircular shape, but may be any shape allowing the light assembly unit 12 to mount to the helmet 10. The light assembly unit 12 also includes a mounting flange 42 which is also shown with an approximately semicircular shape, but may be any shape allowing the flange 42 to cooperate with the downward opening cutout 13 in the face 33. The flange 42 is shown with four flange mounting holes 44 for cooperation with the four holes 48 molded into the exposed lower rim 32 of the helmet (see FIG. 2).

A lens 18 resides over the at least one light element 16. The light elements 16 preferably comprise at least three light elements 16, and more preferably comprise five light elements 16. The light elements 16 are preferably Light Emitting Diodes (LEDs) to provide long battery life. A switch 30 is shown extending through the lens 18, but the switch 30 may, for example, be on a bottom surface of the light assembly unit 12. The switch 30 is preferably water resistant. A soft rear cover 50 resides on a back surface of the light assembly unit 12 to prevent contact of hard surface with a rider's head.

A cross-sectional view of the light assembly unit 12 taken along line 5-5 of FIG. 4B is shown in FIG. 5. The light assembly unit 12 includes a circuit 54 and batteries 52. The batteries 52 provide power for the light elements 16 and the circuit 54 is controlled by the switch 30. In another embodiment, the batteries 52 are positioned at a center for forward location in the helmet 10 to provide better balance where desired, and are connected to the light assembly unit 12 by wires. The circuit 54 may further be designed to optimize the life of the batteries 52, for example, an ON/OFF strobe.

The bicycle rider fastens the helmet in place by means of retention straps with the light toward the rear. The on/off switch is depressed and the LED light sources illuminate the rear surface of the upper torso of bicycle rider increasing visibility of the rider to a vehicle approaching from the rear. The light assembly unit attaches to the occipital cutout of lower rim of helmet by the flange sliding into a groove in occipital cutout of lower rim of helmet (not shown) and plastic nut and bolt not shown) through holes in molded plastic of lower rim of helmet in line with holes in light assembly unit flange.

Alternative embodiments of the present invention include:

The light assembly unit may go across lower space of the cutout 13 not covering all of the cutout area 13;

The light assembly unit flange may insert into a groove in the cutout 13 and be fixed to the lower rim 32 of helmet by means of retention straps using Velcro® fasteners;

The light assembly unit may slide into grooves in the cutout 13 and be glued in place;

The light assembly unit may be fastened to a lower rim of the cutout 13 by a quick release plastic release lever mechanism;

The light assembly unit may comprise an adjustable light assembly unit which enables precise adjustment of the angle of the light beam 22 to maximally illuminate the rear surface of the upper torso of the rider;

The light assembly unit may be an aftermarket light assembly unit with illumination beam directed upon the rear surface of the upper torso of the bicycle rider which attaches to the helmet by means of retention straps laced through the cooling slots 20 in helmet; and

The light assembly unit may be an aftermarket light assembly unit with illumination beam directed upon the rear surface of the upper torso of the bicycle rider which attaches to the helmet by means of a mechanical clamp mechanism.

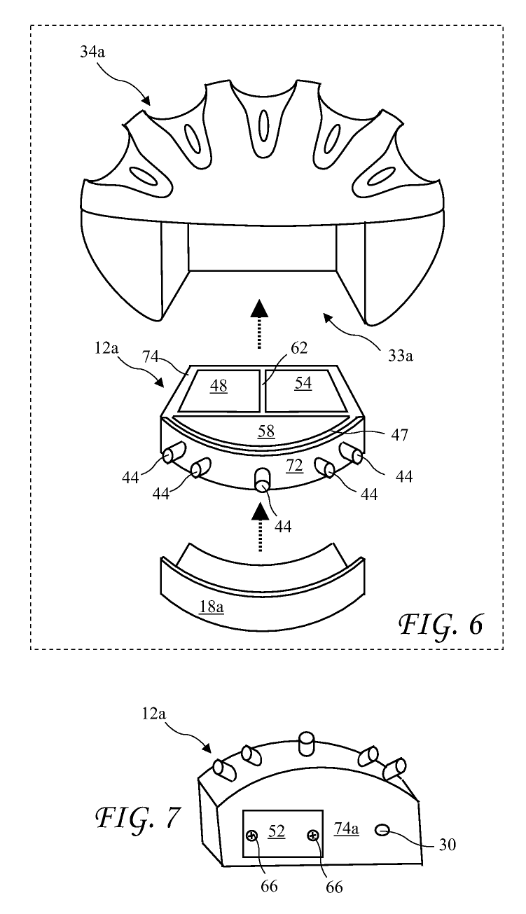

One example of an alternative embodiment of the present invention is a second bicycle helmet 34a which is molded to accept a second light assembly unit 12a according to the present invention, is shown in FIG. 6 and a bottom view of the light assembly unit 12a is shown in FIG. 7. The second light assembly unit 12a includes a housing 74 made to fit a cutout 33a in the bottom of the rear portion of the helmet 34a. The housing 74 includes an arced support partition 47 for mounting of a printed LED circuit 72, a battery compartment 48, an on/off switch 30, a battery compartment door 52, rectangular space 54 and arced space 58 to contain the electronic wiring and any other electronic components. The printed led circuit 72 carries between three and six LED diodes 44 mounted to it and appropriate wiring. The arced space 58 is formed between a long wall partition 60 and the arced support partition 47. The arced support partition 47 is oriented facing rearward and downward with respect to the helmet 34a such that a line 45 perpendicular to the arced support partition 47 is preferably between 30 degrees and 75 degrees below the horizontal axis 46 of the helmet 34a (see FIG. 1). Forward of the arced support partition 47, the two compartments 48 and 54 are separated by a short wall partition 62. The on/off switch 30 and the battery compartment door 52 are located on a bottom surface 74a of the housing 74. A silicone seal is preferably provided to waterproof the on/off switch 30. The battery compartment door 52 includes two battery door mounting screws 66 for securing the battery door to the housing 74. The light assembly unit 12a be fixed to the cutout 33a in the rear surface of the helmet 34a by an appropriate adhesive. A lens 70 shaped in a right angle, resides over the printed LED circuit 72 and LEDs 44 to enclose the light assembly unit 12a

While the invention herein disclosed has been described by means of specific embodiments and applications thereof, numerous modifications and variations could be made thereto by those skilled in the art without departing from the scope of the invention set forth in the claims.

I claim:

1. A rider illuminating bicycle helmet comprising:
a bicycle helmet with an elongated rear portion;
a rearward and downward facing face on the elongated rear portion;
a light assembly unit mounted to the rearward and downward facing face, the light assembly unit comprising:
at least one light element; and
a power source for the at least one light element.

2. The rider illuminating bicycle helmet of claim 1, wherein the at least one light element comprises at least one Light Emitting Diode (LED).

3. The rider illuminating bicycle helmet of claim 2, wherein the at least one LED comprises at least three LEDs.

4. The rider illuminating bicycle helmet of claim 3, wherein the at least one LED comprises five LEDs.

5. The rider illuminating bicycle helmet of claim 1, wherein the light assembly unit has a semi-circular lateral vertical cross-section and a rectangular longitudinal vertical cross-section.

6. The rider illuminating bicycle helmet of claim 1, wherein the light assembly unit includes a lens over the at least one light element.

7. The rider illuminating bicycle helmet of claim 1, wherein the light assembly unit includes a padded back surface for mounting against the bicycle helmet.

8. The rider illuminating bicycle helmet of claim 1, wherein the light assembly unit is mounted to point light beams from the at least one light element in a direction rearward and between 45 and 75 degrees below a horizontal axis of the bicycle helmet.

9. The rider illuminating bicycle helmet of claim 8, wherein the light assembly unit is mounted to point light beams from the at least one light element in a direction rearward and about 60 degrees below the horizontal axis of the bicycle helmet.

10. A rider illuminating bicycle helmet comprising:
a bicycle helmet with an elongated rear portion;
a rearward and downward facing face on the elongated rear portion;
a light assembly unit mounted to the rearward and downward facing face, the light assembly unit comprising:
at least three Light Emitting Diode (LED) light sources pointed rearward and between 45 and 75 degrees below a horizontal axis of the bicycle helmet;
a lens over the LEDs; and
a power source for the at least one light element.

11. A rider illuminating bicycle helmet comprising:
a bicycle helmet with an elongated rear portion;
a rearward and downward facing face on the elongated rear portion;
a light assembly unit mounted to the rearward and downward facing face, the light assembly unit comprising:
at five Light Emitting Diode (LED) light sources pointed rearward and approximately 60 degrees below a horizontal axis of the bicycle helmet;
a lens over the LEDs; and
a power source for the at least one light element.
